(19) United States
(12) Patent Application Publication
(10) Pub. No.: US 2009/0154169 A1
(43) Pub. Date: Jun. 18, 2009

(54) LED LAMP WITH A HEAT SINK

(75) Inventors: JUN LIU, Shenzhen (CN); YONG-DONG CHEN, Shenzhen (CN); SHIH-HSUN WUNG, Tu-Cheng (TW)

Correspondence Address: PCE INDUSTRY, INC.;ATT. Steven Reiss, 458 E. LAMBERT ROAD, FULLERTON, CA, 92835, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/039,637

(22) Filed: Feb. 28, 2008

(30) Foreign Application Priority Data
Dec. 12, 2007 (CN) 200710125005.7

(51) Int. Cl. F21V 7/00; F21V 29/00

(52) U.S. Cl. 362/310; 362/373

(57) ABSTRACT

An LED lamp includes a post (10), a heat sink (20) enclosing the post, an LED module (30) mounted in the post, a holder (40) secured on the LED module, and a lens (50) covering the holder. The heat sink is formed by a plurality of fins (22), each having an annular and planar configuration to contact and surround the post. The fins are parallel to each other and mounted on the post along a length direction of the post. An LED (32) of the LED module is received in the holder, whereby light generated by the LED is reflected by the holder.

### BACKGROUND OF THE INVENTION

1. Field of the Invention

The present invention relates to a light emitting diode (LED) lamp, and more particularly to an LED lamp incorporating a heat sink for enhancing a heat dissipation thereof.

2. Description of Related Art

As an energy-efficient light, an LED lamp has a trend of substituting for the fluorescent lamp for an indoor lighting purpose; in order to increase the overall lighting brightness, a plurality of LEDs are often incorporated into a signal lamp, in which how to efficiently dissipate heat generated by the plurality of LEDs becomes a challenge.

Conventionally, an LED lamp comprises a solid cylinder and a plurality of LEDs mounted on the cylinder. The plurality of LEDs may be arranged in a plurality of lines on a circumferential periphery of the cylinder and along a height direction of the cylinder, or just radially mounted on a top surface of the cylinder. When the plurality of LEDs are activated to lighten, heat generated by the plurality of LEDs is dispersed to ambient air via the cylinder.

The heat dissipating capability of the cylinder is limited since a size limitation of the LED lamp. In order to obtain more heat dissipating areas, the cylinder should be made having a large size. However, it is costly to just increase a volume of the cylinder since much more material is needed when manufacturing the solid cylinder. Furthermore, the increase of the volume of the solid cylinder also causes the LED lamp to become heavy, which may lead an inconvenient transportation or handling thereof.

What is needed, therefore, is an LED lamp with a heat sink which can overcome the above-mentioned disadvantages.

### SUMMARY OF THE INVENTION

An LED lamp includes a post, a heat sink enclosing the post, an LED module mounted in the post, a holder secured on the LED module, and a lens covering the holder. The heat sink is formed by a plurality of parallel fins, each having an annular and planar configuration to contact and surround the post. Since the heat sink is formed around the post, heat generated by an LED of the LED module is able to be conducted via the post to the heat sink, which dissipates the heat to the ambient air sufficiently since the fins of the heat sink have a large heat dissipating area. Furthermore, a light weight and low cost of the plurality of fins facilitate a transportation and handling of the LED lamp and reduce a total cost of the LED lamp.

Other advantages and novel features of the present invention will become more apparent from the following detailed description when taken in conjunction with the accompanying drawings, in which:

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an assembled, isometric view of an LED lamp with a heat sink in accordance with a preferred embodiment of the present invention;

FIG. 2 is an exploded view of FIG. 1; and

FIG. 3 is a top view of a post of the LED lamp of FIG. 1.

### DETAILED DESCRIPTION OF THE INVENTION

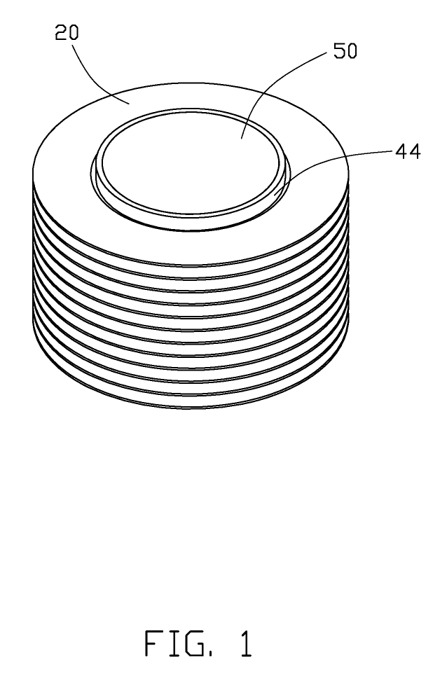

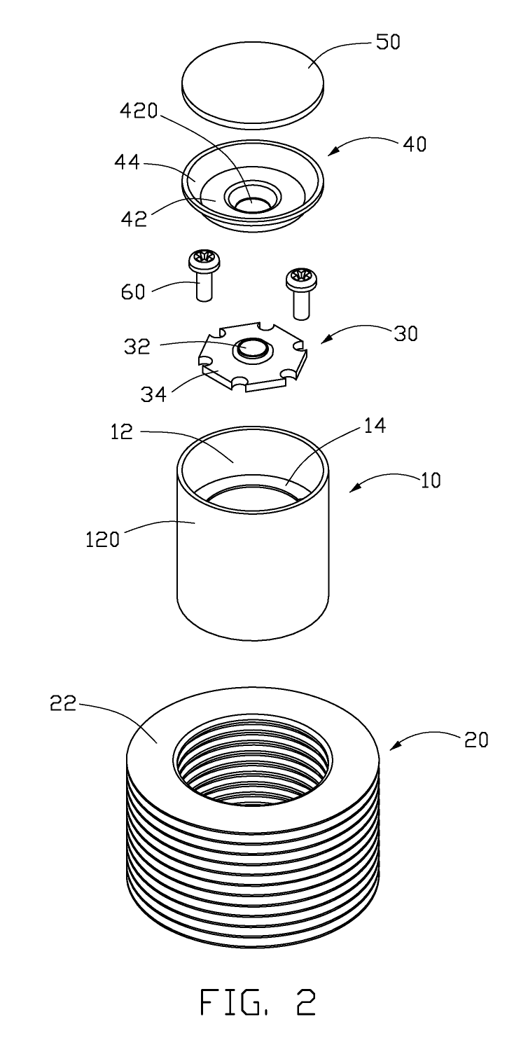

Referring to FIGS. 1 and 2, an LED lamp in accordance with a preferred embodiment of the present invention comprises a post 10, a heat sink 20 mounted around the post 10, an LED module 30 resting on the post 10, a holder 40 fixed on the LED module 30, and a lens 50 disposed above the heat sink 20 and covering the holder 40.

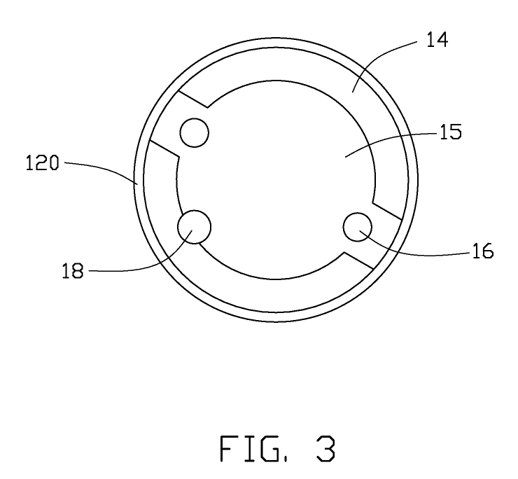

The post 10 has a solid, cylindrical configuration and is made of metal having good heat conducting capability, such as copper, aluminum, or an alloy thereof. The post 10 defines an opening 12 in an upper portion thereof and has an annular sidewall 120 around the opening 12. Also illustrated in FIG. 3, a pair of curved, inwardly projecting protrusions 14 are formed by the post 10, located below the opening 12, wherein each of the pair of curved protrusions 14 has an outer circumference coupling with an inner periphery of the sidewall 120, and an inner circumference being coaxial with the outer circumference. The inner circumference and the outer circumference of the protrusion 14 have a common center with that of the post 10. A gap (not labeled) is defined between two confronting ends of the pair of curved protrusions 14. The pair of curved protrusions 14 are used for positioning the LED module 30 in the opening 12 as the LED module 30 is assembled to the post 10. A pair of threaded holes 16 are defined in a base 15 of the post 10, located corresponding to the gaps, respectively, for threadedly receiving screws 60 therein. A through hole 18 is defined through a portion of the inner circumference of one of the pair of curved protrusions 14 and the base 15 of the post 10. The through hole 18 is used for extending a wire (not shown) through the post 10 to electrically connect to the LED module 30 with a power source.

Please referring back to FIG. 2, the heat sink 20 consists of a plurality of parallel fins 22 each having a planar, annular shape. Each of the plurality of fins 22 has an interior diameter similar to an exterior diameter of the post 10, whereby the plurality of fins 22 can be mounted around the post 10. The plurality of fins 22 are securely mounted around the post 10 along the height direction of the post 10 by soldering in a manner that the plurality of fins 22 are spaced from each other with equal and predetermined distances therebetween. The plurality of fins 22 occupies a whole circumferential periphery of the post 10 to thereby totally receive the post 10 therein, which is shown in FIG. 1. Thus, the LED lamp in accordance with the present invention can have a large heat dissipating area.

As shown in FIGS. 1-2, the LED module 30 comprises a printed circuit board 34 having a floral shape, and an LED 32 mounted on a center of the printed circuit board 34. The LED module 30 is fixed on the base 15 of the post 10 by extending the screws 60 through corresponding recesses (not labeled) in an edge of the printed circuit board 34 to screw into the pair of threaded holes 16 in the base 15 of the post 10, respectively. At this fixed position, the LED module 30 is surrounded by the pair of curved protrusions 14. When the LED 32 is activated to lighten, heat generated by the LED 32 is conducted to the post 10 via the printed circuit board 34, and then transferred to the heat sink 20.

The holder 40 is disposed on the LED module 30 in a manner that it has a disk-like lower portion 42 accommodated in the opening 12 of the post 10, and a tapered upper portion 44 located upon a top end of the post 10 (illustrated in FIG. 1). The holder 40 defines a hole 420 in a center of the lower portion 42 for extension of the LED 32 into the holder 420, whereby light emitted from the LED 32 is able to be reflected by an inner surface of the holder 40 to radiate through the lens 50 to illuminate an object outside the LED lamp.

The lens 50 is received into the tapered upper portion 44 of the holder 40 for concentrating the light produced by the LED 32 into a light beam, whereby the LED lamp can project the light with sufficient intensity. In addition, the lens 50, which covers the holder 40 can protect the LED module 30 from damage or contamination.

Since the plurality of fins 22 formed around and contacting the post 10 provides a large amount of heat dissipating areas to the LED lamp, the heat generated by the LED 32 can be dissipated to the ambient via the plurality of fins 22 very efficiently and sufficiently, thus preventing the LED 32 from overheating or failing. Therefore, the post 10 does not need to be made having a large size to obtain a high heat dissipating capability. In contrast to the conventional LED lamp that increases the heat dissipating areas just by increasing the volume of the post 10, which is solid, the cost of the plurality of fins 22 of the present invention added onto the post 10 is relatively low, and the weight of the plurality of fins 22 is light as well; thus, a total cost of the LED lamp is reduced, and a convenient handling or transportation of the LED lamp is achieved. On the other hand, compared to those LED lamps which form the fins 22 integrally on the post 10, the heat sink 20 can be changed to a new one which has a suitable size according to different demands, before it is soldered to the post 10. Thus, the LED lamp in accordance with the present invention can be more easily modified to meet different requirements than the conventional LED lamp.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An LED lamp comprising:
a cylindrical post defining an opening therein;
an LED module received in the opening;
a holder mounted on the LED module and partly received in the opening, wherein at least an LED of the LED module is received in the holder whereby a light generated by the at least an LED is reflected by the holder;
a lens accommodated in the holder and covering the at least an LED of the LED module; and
a heat sink consisting of a plurality of parallel fins each having an annular configuration surrounding the post, whereby heat generated by the at least an LED is dissipated by the fins via the post.

2. The LED lamp as claimed in claim 1, wherein the opening is defined in an upper portion of the post so that the post forms an annular sidewall around the opening.

3. The LED lamp as claimed in claim 2, wherein a pair of curved protrusions are formed in the post below the opening, the LED module being surrounded by the curved protrusions.

4. The LED lamp as claimed in claim 3, wherein each of the pair of curved protrusions has an outer periphery connecting with an inner circumference of the annular sidewall, and an inner periphery coaxial with the outer periphery thereof.

5. The LED lamp as claimed in claim 3, wherein a pair of gaps are defined between confronting ends of the pair of curved protrusions, respectively.

6. The LED lamp as claimed in claim 5, wherein a pair of threaded holes are defined in a base of the post, located corresponding to the pair of gaps, and a through hole is defined through the base of the post and a part of one of the pair of curved protrusions.

7. The LED lamp as claimed in claim 1, wherein the each of the plurality of fins is planar and mounted around the post.

8. The LED lamp as claimed in claim 1, wherein the plurality of fins is equidistantly spaced from each other and occupies a whole circumferential periphery of the post.

9. The LED lamp as claimed in claim 1, wherein the heat sink is fixed on the post by soldering.

10. The LED lamp as claimed in claim 1, wherein the holder has a lower portion shaped like a disk received in the opening, and a tapered upper portion located over a top of the post and receiving the lens therein.

11. An LED lamp comprising:
a cylindrical support having a pair of arced strips thereon;
an LED module mounted on the cylindrical support and surrounded by the pair of arced strips; and
a plurality of fins stacked around the cylindrical support along a height direction thereof, wherein each of the plurality of fins has an annular and planar configuration mounted around the cylindrical support.

12. The LED lamp as claimed in claim 1, wherein a pair of threaded holes is defined in the cylindrical support and between confronting ends of the pair of arced strips respectively.

13. The LED lamp as claimed in claim 1, wherein the post further has an annular sidewall surrounding an opening above the pair of arced strips.

14. The LED lamp as claimed in claim 13, wherein the plurality of fins totally receive the cylindrical support together with the annular sidewall therein.

15. The LED lamp as claimed in claim 14, wherein the plurality of fins are parallel to and equidistantly spaced from each other.

16. The LED lamp as claimed in claim 13 further comprising a holder mounted on the LED module, the holder having a disk enclosed by the annular sidewall and a tapered body located over a top end of the annular sidewall, and a lens fixed in the tapered body of the holder.

17. An LED lamp comprising:
a cylindrical post having a recessed top end and a mounting portion below the recessed top end;
an LED module received in the recessed top end and secured to the mounting portion;
a holder received in the recessed top end, wherein least an LED of the LED module is received in the holder so that a light generated by the at least an LED is reflected by the holder, the holder having a tapered upper portion located over the recessed top end; and
a plurality of parallel fins soldered to a circumferential periphery of the post along a length direction thereof.
